(19) United States
(12) Patent Application Publication
(10) Pub. No.: US 2023/0051624 A1
(43) Pub. Date: Feb. 16, 2023

(54) METHODS TO MECHANICALLY RETAIN, ATTACH, AND SEAL ORIENTED THERMOPLASTIC COMPOSITES AND STRUCTURE

(71) Applicant: CPI ESSCO Inc., Ayer, MA (US)

(72) Inventors: Anatol Kwartler, Maynard, MA (US); Mark V. Wassib, Billerica, MA (US); John R. Courter, Malden, MA (US)

(21) Appl. No.: 17/973,783

(22) Filed: Oct. 26, 2022

Related U.S. Application Data
(63) Continuation of application No. 16/374,658, filed on Apr. 3, 2019, now abandoned.

(51) Int. Cl. H01Q 1/42; B32B 27/40

(52) U.S. Cl. CPC H01Q 1/42; B32B 27/40

(57) ABSTRACT

A method or device designed to retain, attach and seal thermoplastic composite structures in a manner that ensures weather tightness, structural integrity, and ruggedized capability of the installation.

### FIELD OF THE INVENTION

A method or device designed to retain, attach and seal thermoplastic composite material structures in a manner that ensures weather tightness, structural integrity, and ruggedized capability of the installation.

### BACKGROUND OF THE INVENTION

U.S. Pat. No. 5,182,155 relates to a radome structure providing high ballistic protection with low signal loss. The radome has a composite wall structure including alternating layers of polyethylene fiber laminating material which provides high ballistic protection with low signal loss and fiberglass honeycomb core material.

U.S. Pat. No. 7,560,400 relates to a radome comprising flexible composite fabric material including polyester-polyacrylate fibers in a flexible resin matrix material. This reduces radio frequency transmission losses while at the same time providing high strength.

U.S. Pat. No. 7,671,801 relates to an electronically scanned ray that includes a plurality of armor segments interspersed between a plurality of transmit/receive integrated microwave modules, and a clamping element compressing the armor segments. Such an armor facilitates a smaller footprint than a radome.

U.S. Pat. No. 7,681,485 relates to a laminated, optically transparent, ballistic resistant structure having a first transparent layer, a second transparent layer of ceramic tiles spread across the first layer, and a third transparent layer. The first and third layers are bonded to opposite sides of the second layer by transparent adhesive.

U.S. Pat. No. 7,688,278 relates to a ballistic protective radome consisting of longitudinal layer members densely packed in a uniform array forming a main protective layer. The layer members are electrically isolated such that a continuous gap is formed in the main protective layer. The layer members are made of mechanical energy absorbing and high tensile strength materials. The surface of the layer members is electrically conducting.

U.S. Pat. No. 8,054,239 relates to a honeycomb-backed armored radome. The radome is configured to extend over an opening of an antenna and includes a rigid layer underlying a ballistic-resistant layer. The rigid layer includes a honeycomb based material having a plurality of holes that extend transversely to the surface of the ballistic resistant layer.

U.S. Pat. No. 8,368,610 relates to a shaped ballistic radome that comprises a system for shielding transmission devices for ballistic deflection and protection of antenna equipment.

U.S. Pat. No. 8,599,095 relates to a broad band ballistic resistant radome. The invention relates to a radome cover for a RF sensor that comprises a first and second ballistic layer each having a ceramic layer. The two ballistic layers are sandwiched between at least two matching layers and the matching layers are impedance matched to the ceramic layers. The radome cover provides ballistic protection for the RF sensor.

U.S. Pat. No. 9,385,423 relates to a protective ballistic radome for a satellite antenna which can turn about an axis of rotation and has a circular support in the form of a ring. The walls have their lower ends inserted into an annular groove of the circular support to form a ballistic wall in the form of a tube of a circular section having the same axis of revolution about the satellite antenna.

U.S. Pat. No. 9,669,568 relates to a process for producing a three-dimensionally shaped article comprising: providing a structure containing a plurality of films or tapes of uni-directionally oriented polymer and forming the structure into a three-dimensionally shaped article by applying a force under the melting point of the oriented polymer. Shaped articles thus obtained are suitable for use as anti-ballistic articles.

U.S. Patent publication 2010/0166994 relates to a curved armor product. The armor product is produced by a filament winding process in which a plurality of reinforcing elements in the form of fibers or tapes are impregnated with a polymer matrix and wound onto a mandrel. The polymer matrix comprises a solution or dispersion of a polymer in a carrier fluid which is partly evaporated during winding. The armor product comprises a high amount of reinforcing elements with respect to the total mass of the product.

U.S. Patent publication 2011/0159233 relates to a process for manufacturing a curved product comprising positioning a plurality of drawn polymeric reinforcing elements onto a mandrel, adhering at least part of the elements to each other, and removing the product from the mandrel. The curved article is preferably an armor article which has good anti-ballistic properties and is substantially free from wrinkles.

U.S. Patent Publication 2014/0000796 relates to a curved armor product produced by a filament winding process in which a plurality of the reinforcing elements are in the form of fibers or tapes that are impregnated with a polymer matrix and wound onto a mandrel. The polymer matrix comprises a solution or dispersion of a polymer in a carrier fluid which is partly evaporated during or after winding. The armor product comprises a high amount of reinforcing elements with respect to the total mass of the product.

U.S. Patent Publication 2014/0078016 relates to a material for radomes. The material comprises at least one laminate component containing polymeric fibers wherein the material has a loss tangent of less than 8×10.sup.-3 radians as measured at a frequency chosen from the group of frequencies consisting of 1.8 GHz; 3.9 GHz; 10 GHz; 39.5 GHz; and 72 GHz.

U.S. Patent Publication 2015/0033936 relates to composite panel comprising at least one layer containing at least one tape comprising a thermoplastic polymer selected from the group consisting of polyolefins, polyesters, polyvinyl alcohols, polyacrylonitriles, polyamides or polyketone, and an adhesive in contact with said layer, wherein the adhesive is a plastomer wherein said plastomer is a random copolymer of ethylene or propylene, the tape comprises an ultra-high molecular weight polyethylene. The composite panel is used in a ballistic resistant article.

U.S. Patent Publication 2015/0222011 relates to composite radome wall structures that exhibit both antiballistic and radar transparency properties and include an antiballistic internal solid, void-free core and external antireflective (A R) surface layers which sandwich the core. The antiballistic core can be a compressed stack of angularly biased unidirectional polyethylene monolayers formed of tapes and/or fibers. Face sheets and/or one or more impedance matching layers may optionally be positioned between the antiballistic core.

U.S. Patent Publication 2016/0178327 relates to ballistic resistant sheets and articles such as curved ballistic resistant armor and helmets. The ballistic resistant sheets are a multi-layer monolayer construction including a core layer having first unidirectional oriented reinforcing fibers and an elastomeric material sandwiched between the face layers.

U.S. Patent Publication 2016/0380345 relates to composite anti-ballistic radome walls that have radar transparency properties and include an anti-ballistic internal solid, void-free core and external antireflective surface layers which sandwich the core.

### SUMMARY OF THE INVENTION

The present invention relates to utilizing a joggle, or feature that is out of plane with a surface being retained, that allows a linearly oriented thermoplastic structure to be retained into an adjacent assembly. It is an object of the present invention for the joggle to be designed in a manner that if needed, seals water tightness, airtightness and resistance to sand and dust. The present invention relates to linearly oriented thermoplastic structures attached to a surface to create a weather tight ruggedized closure.

It is an object of the present invention for common thermoplastics used in the present invention to be comprised of High Density Polyethylene. Ultra High Molecular Weight Polyethylene, Polypropylene, Aramid or any combination thereof.

The present invention comprises a linearly oriented thermoplastic composite that comprises a radome shell, an adhesive/sealant, a lower ring, an upper ring and a sealing gasket.

### BRIEF DESCRIPTION OF THE DRAWINGS

FIG. 1 shows an embodiment of a radome device of the present invention.

FIG. 2 shows an embodiment of a radome device of the present invention.

FIG. 3 shows an embodiment of a rugged radome system assembly of the present invention.

FIG. 4 shows an embodiment of a top ring of a rugged radome assembly of the present invention.

FIG. 5 shows an embodiment of a lower ring of a rugged radome assembly of the present invention.

### DETAILED DESCRIPTION

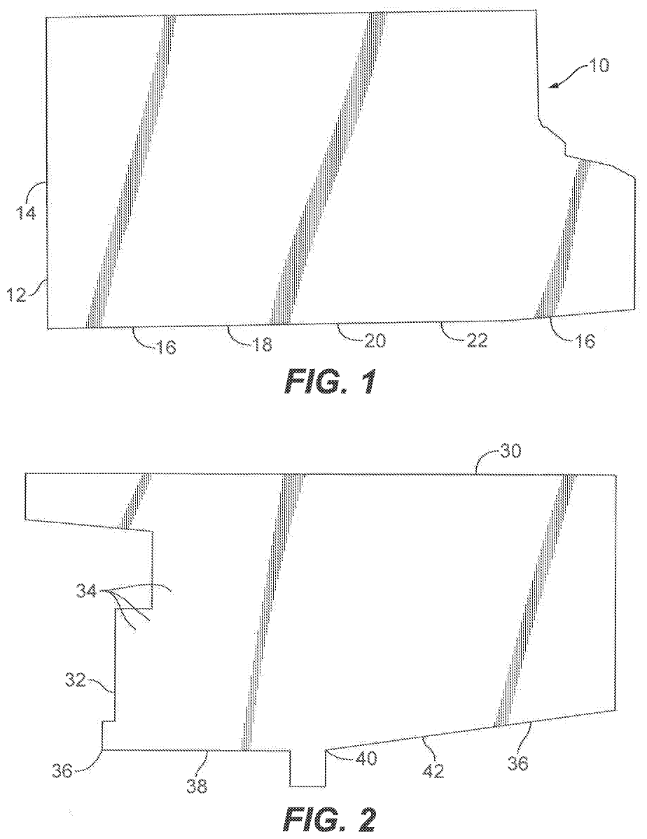

FIG. 1 shows the rugged radome 10 having a radome shell 12, and an adhesive/sealant 14. The radome has a lower ring 16 and an upper ring 22. The radome further comprises a sealing gasket 18 and a ring assembly screw 20.

FIG. 2 shows the rugged radome 30 having a radome shell 32 and an adhesive/sealant 34. The radome has a lower ring 36 and an upper ring 42. The radome further comprises a sealing gasket 38 and a mounting screw 40.

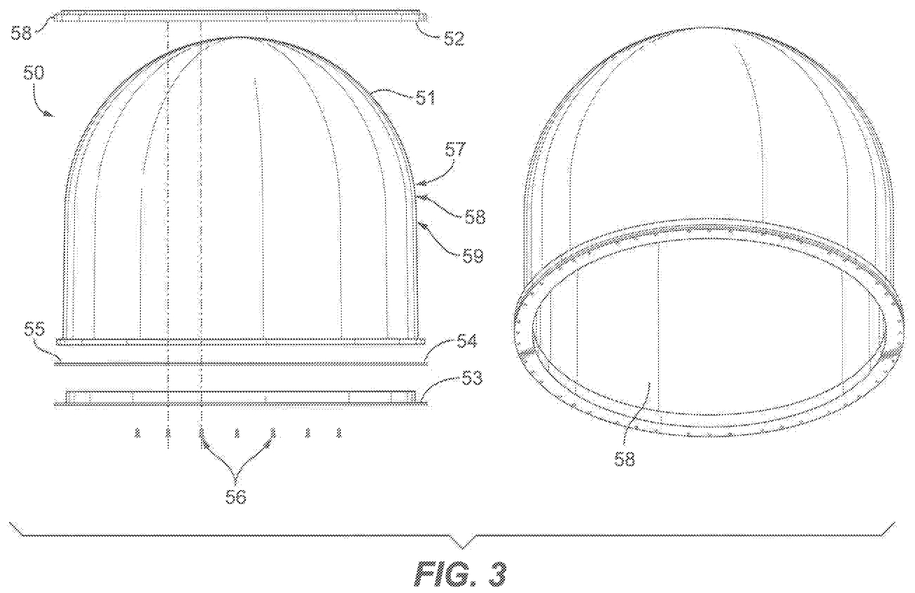

FIG. 3 shows a rugged radome system assembly. Radome 50 is comprised of a radome shell 51, top ring 52 and a lower ring 53. The radome 50 further comprises a gasket 54, polyurethane adhesive 55, and a screw 56. The radome 50 further comprises a Polane S Plus 57, clear primer 58 and a Polane Spray 59.

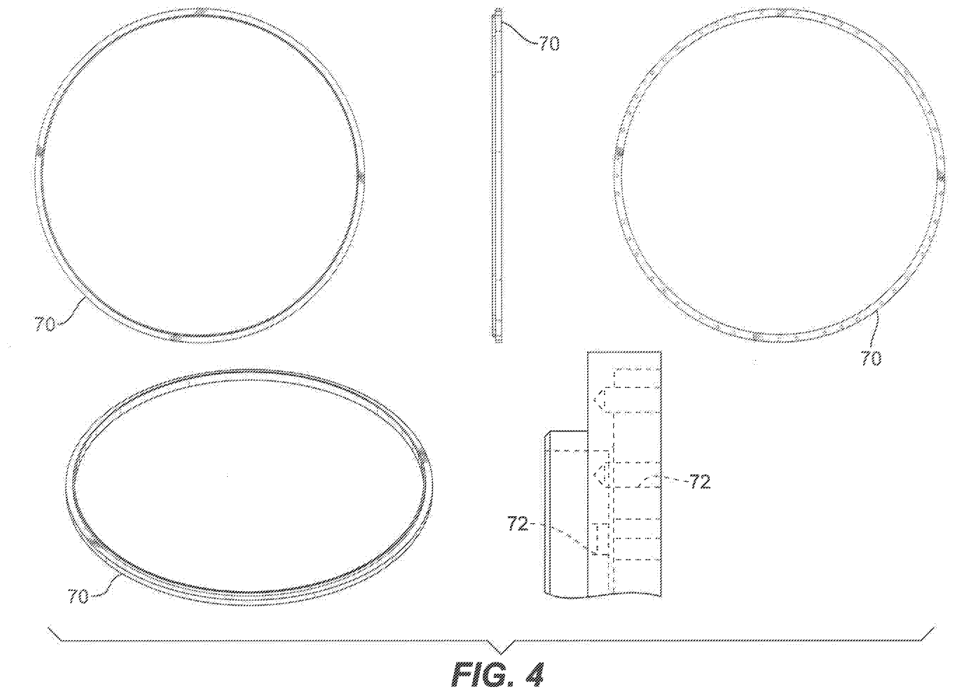

FIG. 4 shows different views of the top ring 70. In an embodiment, the top ring 70 is made of an aluminum alloy. The top ring 70 has a tapped hole 72.

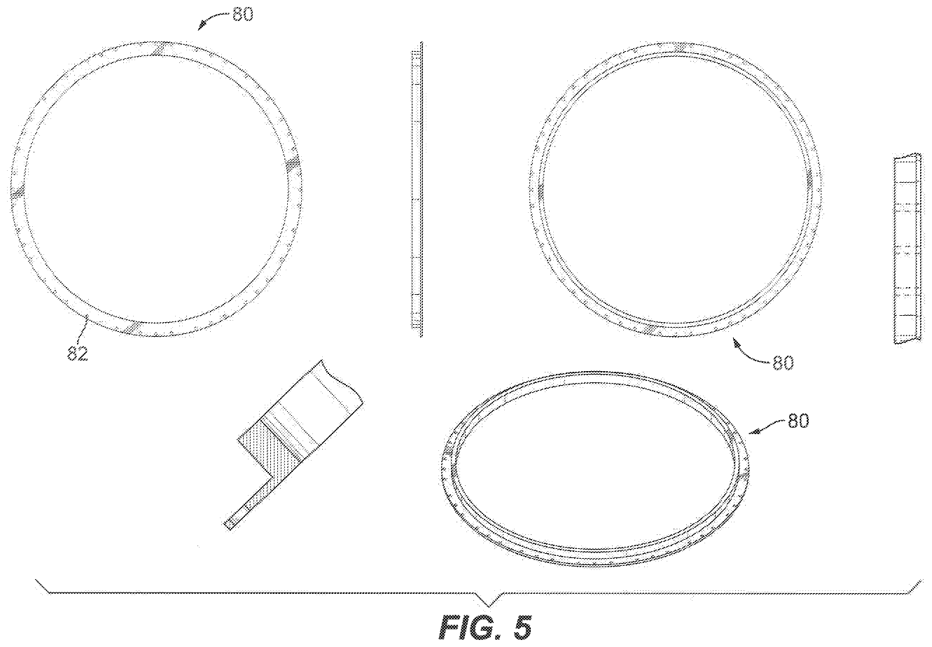

FIG. 5 shows different view of the lower ring 80. In an embodiment the lower ring 80 is made of an aluminum alloy. The lower ring 80 has a screw hole circle 82.

1. Linearly oriented thermoplastic structures comprising:
a joggle, or feature that is out of plane with surface being retained, so that a thermoplastic structure is retained in an adjacent assembly;
said joggle adapted to be utilized with seals for water tightness, airtightness and resistance to sand and dust;
said structure creating a weather tight ruggedized closure.

2.-4. (canceled)
